(19) United States
(12) Patent Application Publication
(10) Pub. No.: US 2010/0288096 A1
(43) Pub. Date: Nov. 18, 2010

(54) CUTTING MECHANISM

(75) Inventor: Chien-Kuo Kuan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/500,440

(22) Filed: Jul. 9, 2009

(30) Foreign Application Priority Data
May 15, 2009 (TW) 098116107

(51) Int. Cl. B26D 1/18

(52) U.S. Cl. 83/485

(57) ABSTRACT

A cutting mechanism includes a first cutter assembly, a first cutter assembly sheath, a first guiding shaft, a second cutter assembly, a second cutter assembly sheath, a second guiding shaft, a lead screw, a lead screw sheath, and a connecting element. The first cutter assembly and the second cutter assembly are simultaneously driven by the single lead screw, thereby cutting a sheet-like article.

### FIELD OF THE INVENTION

The present invention relates to a cutting mechanism, and more particularly to a cutting mechanism having a single lead screw.

### BACKGROUND OF THE INVENTION

A cutting mechanism is used for cutting sheet articles such as papers. In views of expanded functions and cost-effectiveness, a variety of cutting mechanisms have been developed in order to meet the diversified demand.

Take a common receipt cutting mechanism having lead screws for example. FIG. 1 is a schematic perspective view illustrating a conventional receipt cutting mechanism. During operation of the cutting mechanism 1, a sheet-like article (not shown) is introduced into the inlet of the cutting mechanism 1 in the feeding direction I, and then the sheet-like article is cut to a receipt having a desired width.

Please refer to FIG. 1 again. The cutting mechanism 1 comprises a first cutter assembly 10, a second cutter assembly 11, a first cutter assembly sheath 12, a second cutter assembly sheath 13, a first guiding shaft 14, a second guiding shaft 15, a first lead screw sheath 16 and a second lead screw sheath 17, a first lead screw 18, and a second lead screw 19. The first cutter assembly 10 comprises a first cutter frame 101 and a first blade 102. The first blade 102 is circumferentially arranged on the external surface of the first cutter frame 101. The second cutter assembly 11 comprises a second cutter frame 111 and a second blade 112. The second blade 112 is circumferentially arranged on the external surface of the second cutter frame 111.

The first guiding shaft 14 penetrates through the first cutter assembly 10. The second guiding shaft 15 penetrates through the second cutter assembly 11. The first cutter assembly sheath 12 and the second cutter assembly sheath 13 are used for clamping the first cutter assembly 10 and the second cutter assembly 11, respectively. As such, the first cutter assembly 10 and the second cutter assembly 11 are permitted to move along the first guiding shaft 14 and the second guiding shaft 15, respectively. Moreover, the first lead screw sheath 16 is connected to the first cutter assembly sheath 12, and the first lead screw 18 penetrates through the first lead screw sheath 16. The second lead screw sheath 17 is connected to the second cutter assembly sheath 13, and the second lead screw 19 penetrates through the second lead screw sheath 17.

Before the sheet-like article is introduced into the inlet of the cutting mechanism 1, the first cutter assembly sheath 12 and the second cutter assembly sheath 13 are respectively moved along the first lead screw 18 and the second lead screw 19 upon rotation of the first lead screw 18 and the second lead screw 19. As such, the first cutter assembly sheath 12 and the second cutter assembly sheath 13 are simultaneously moved to a cutting position where a desired width of the receipt is determined. Next, as the first guiding shaft 14 and the second guiding shaft 15 are rotated, the first cutter assembly 10 and the second cutter assembly 11 are simultaneously driven to rotate. Consequently, the sheet-like article is cut to a receipt having a desired width by the first blade 102 on the first cutter frame 101 and the second blade 112 on the second cutter frame 111.

The conventional cutting mechanism shown in FIG. 1, however, still has some drawbacks. For example, for enhancing the cutting efficacy, the first blade 102 and the second blade 112 need to be sustained against each other, and thus the method for controlling simultaneous rotation of the first lead screw 18 and the second lead screw 19 become more critical. In addition, the uses of two lead screws are not cost-effective.

Therefore, there is a need of providing an improved cutting mechanism so as to obviate the drawbacks encountered from the prior art.

### SUMMARY OF THE INVENTION

It is an object of the present invention to provide a cutting mechanism having a single lead screw for cutting sheet-like articles.

In accordance with an aspect of the present invention, there is provided a cutting mechanism for cutting a sheet-like article. The cutting mechanism includes a first cutter assembly, a first cutter assembly sheath, a first guiding shaft, a second cutter assembly, a second cutter assembly sheath, a second guiding shaft, a connecting element, a lead screw sheath, and a lead screw. The first cutter assembly is used for cutting the sheet-like article. The first cutter assembly sheath is for clamping the first cutter assembly. The first guiding shaft penetrates through the first cutter assembly. The first cutter assembly is movable along the first guiding shaft. The second cutter assembly is used for cutting the sheet-like article. The second cutter assembly sheath is used for clamping the second cutter assembly. The second guiding shaft penetrates through the second cutter assembly. The second cutter assembly is movable along the second guiding shaft. The connecting element has both ends respectively connected to the first cutter assembly sheath and the second cutter assembly sheath, so that the first cutter assembly sheath and the second cutter assembly sheath are simultaneously moved. The lead screw sheath is connected to the first cutter assembly sheath. The lead screw penetrates through the lead screw sheath. The lead screw sheath is moved along the lead screw upon rotation of the lead screw, so that the first cutter assembly sheath and the second cutter assembly sheath are simultaneously moved to a cutting position, and the sheet-like article at the cutting position is cut by the first cutter assembly and the second cutter assembly.

In an embodiment, the first cutter assembly includes a first cutter frame and a first blade, and the second cutter assembly includes a second cutter frame and a second blade.

In an embodiment, the first blade is disposed on the first cutter frame, and the second blade is disposed on the second cutter frame.

In an embodiment, the connecting element is arranged behind the first blade and the second blade, and the connecting element has a tapering protrusion for guiding the shredded sheet-like article to be ejected along an exit path.

In an embodiment, a protruding edge is further circumferentially arranged on a periphery of the first cutter frame.

In an embodiment, the cutting mechanism further includes a spring sheathed around the first cutter frame. An end of the spring is sustained against the protruding edge, so that the first blade is sustained against the second blade.

In an embodiment, the first guiding shaft and the second guiding shaft are square-section shafts.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a conventional receipt cutting mechanism;

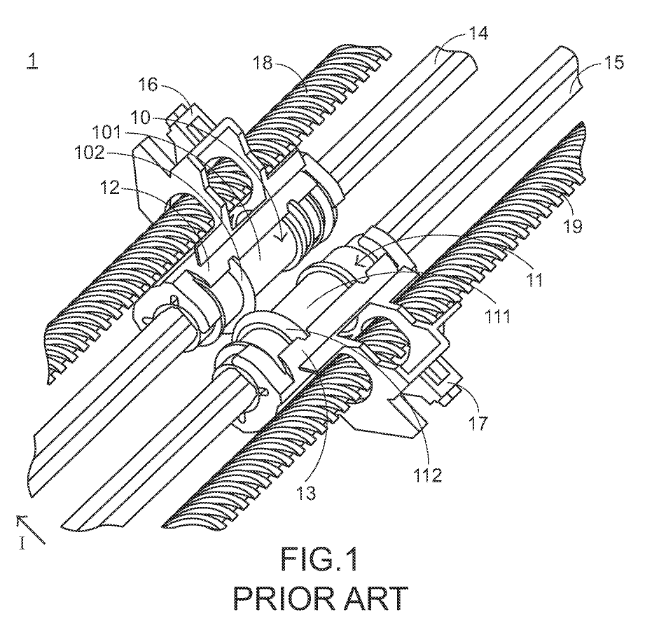

FIG. 2A is a schematic front view illustrating the outward appearance of a cutting mechanism according to an embodiment of the present invention;

FIG. 2B is a schematic rear view illustrating the outward appearance of a cutting mechanism according to the embodiment of the present invention;

FIG. 3 is a schematic perspective view illustrating a portion of the cutting mechanism according to the embodiment of the present invention;

FIG. 4 is a schematic perspective view illustrating another portion of the cutting mechanism according to the embodiment of the present invention; and

FIG. 5 is a schematic perspective view illustrating a process of performing a cutting operation according an embodiment of the present invention.

### DETAILED DESCRIPTION OF THE PREFERRED EMBODIMENT

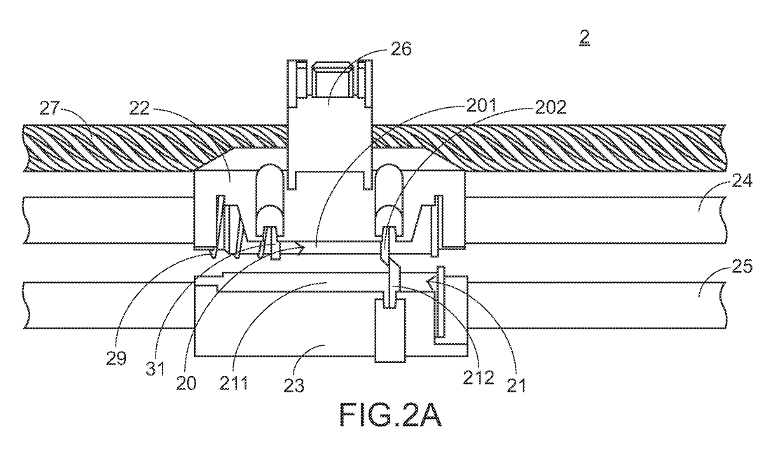

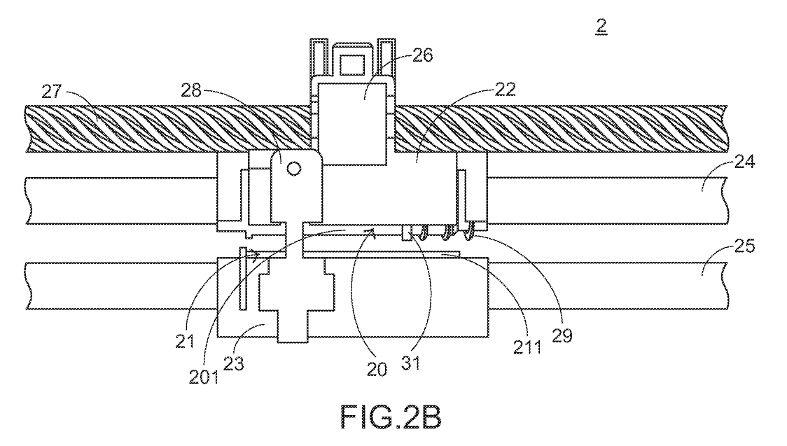

FIG. 2A is a schematic front view illustrating the outward appearance of a cutting mechanism according to an embodiment of the present invention. FIG. 2B is a schematic rear view illustrating the outward appearance of a cutting mechanism according to the embodiment of the present invention. As shown in FIGS. 2A and 2B, the cutting mechanism 2 comprises a first cutter assembly 20, a second cutter assembly 21, a first cutter assembly sheath 22, a second cutter assembly sheath 23, a first guiding shaft 24, a second guiding shaft 25, a lead screw sheath 26, a lead screw 27, a connecting element 28 and a spring 29. The first cutter assembly 20 comprises a first cutter frame 201 and a first blade 202. The second cutter assembly 21 comprises a second cutter frame 211 and a second blade 212.

The first guiding shaft 24 penetrates through the first cutter assembly 20. The second guiding shaft 25 penetrates through the second cutter assembly 21. The first cutter assembly sheath 22 and the second cutter assembly sheath 23 are used for clamping the first cutter assembly 20 and the second cutter assembly 21, respectively. As such, the first cutter assembly 20 and the second cutter assembly 21 are permitted to move along the first guiding shaft 24 and the second guiding shaft 25, respectively.

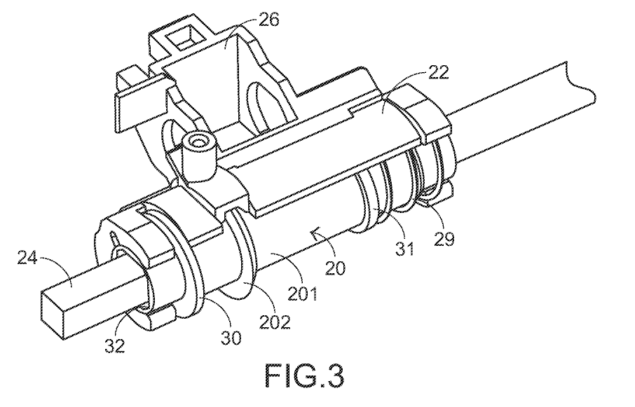

FIG. 3 is a schematic perspective view illustrating a portion of the cutting mechanism according to the embodiment of the present invention. As shown in FIG. 3, the first blade 202 is circumferentially arranged on the external surface of the first cutter frame 201. Moreover, a first protruding edge 30 is circumferentially arranged on the periphery at a first side of the first cutter frame 201. The first protruding edge 30 is clamped by the first cutter assembly sheath 22. In addition, a second protruding edge 31 is circumferentially arranged on the periphery at a second side of the first cutter frame 201.

The spring 29 is sheathed around the first cutter frame 201 and arranged between the second protruding edge 31 and the first cutter assembly sheath 22. An end of the spring 29 is sustained against the second protruding edge 31. Due to the elastic force offered by the spring 29, the first blade 202 is sustained against the second blade 212.

Moreover, the first cutter assembly 20 has a square-section channel 32. The first guiding shaft 24 penetrates through the square-section channel 32. For complying with the square-section channel 32, the first guiding shaft 24 is a square-section shaft, so that the first cutter assembly 20 is movable along the first guiding shaft 24. In addition, the first cutter assembly 20 is simultaneously rotated with the rotation of the first guiding shaft 24.

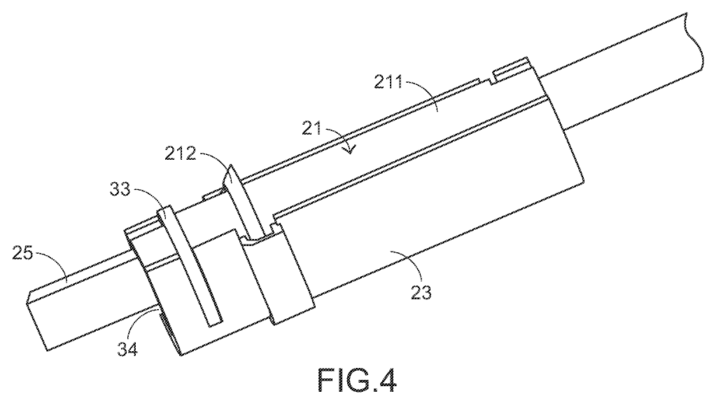

FIG. 4 is a schematic perspective view illustrating another portion of the cutting mechanism according to the embodiment of the present invention. As shown in FIG. 4, the second blade 212 is circumferentially arranged on the external surface of the second cutter frame 211. Moreover, a protruding edge 33 is circumferentially arranged on the periphery at a first side of the second cutter frame 211. The protruding edge 33 is clamped by the second cutter assembly sheath 23. Moreover, the second cutter assembly 21 has a square-section channel 34. The second guiding shaft 25 penetrates through the square-section channel 34. For complying with the square-section channel 34, the second guiding shaft 25 is a square-section shaft, so that the second cutter assembly 21 is movable along the second guiding shaft 25. In addition, the first cutter assembly 21 is simultaneously rotated with the rotation of the second guiding shaft 25.

Please refer to FIG. 2 again. Both ends of the connecting element 28 are respectively connected to the first cutter assembly sheath 22 and the second cutter assembly sheath 23, so that the first cutter assembly sheath 22 and the second cutter assembly sheath 23 are simultaneously moved. The lead screw sheath 26 is connected to the first cutter assembly sheath 22. The lead screw 27 penetrates through the lead screw sheath 26. Upon rotation of the lead screw 27, the lead screw sheath 26 is moved along the lead screw 27.

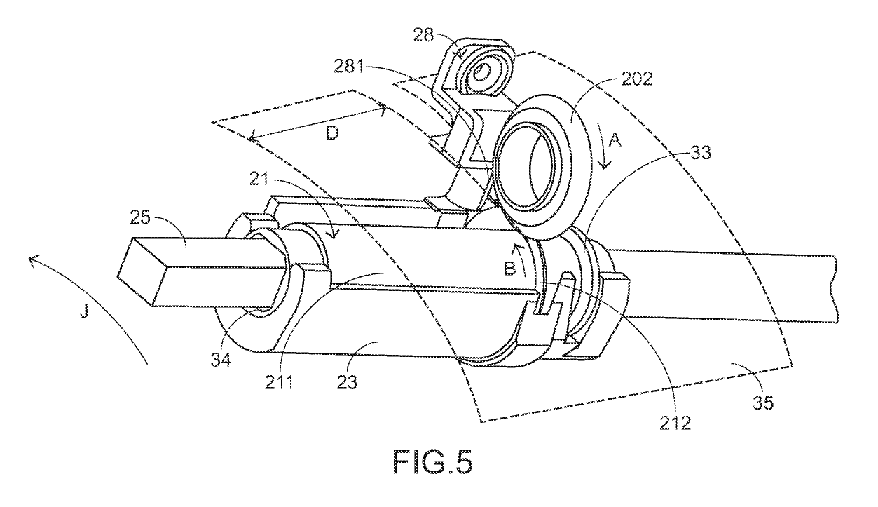

Hereinafter, the operations of the cutting mechanism 2 will be illustrated with FIG. 5. FIG. 5 is a schematic perspective view illustrating a process of performing a cutting operation according an embodiment of the present invention. Before a sheet-like article 35 (e.g. a receipt) is introduced into the cutting mechanism 2, the user may rotate the lead screw 27 to drive movement of the first cutter assembly sheath 22 and the second cutter assembly sheath 23 to the cutting position according to the desired width D of the sheet-like article 35. Next, the sheet-like article 35 is introduced into the cutting mechanism 2 in the direction J. Upon rotation of the first guiding shaft 24 and the second guiding shaft 25, the first cutter assembly sheath 22 and the second cutter assembly sheath 23 are driven to rotate. At the same time, the first blade 202 and the second blade 212, which are respectively arranged on the first cutter frame 201 and the second cutter frame 211, are rotated toward the directions A and B. Consequently, the sheet-like article 35 is cut into a receipt having the desired width D. As shown in FIG. 5, the connecting element 28 is arranged behind the first blade 202 and the second blade 212. In addition, the connecting element 28 has a tapering protrusion 281 for guiding the shredded sheet-like article 35 to be ejected along the exit path.

From the above description, since the connecting element 28 are connected to the first cutter assembly sheath 22 and the second cutter assembly sheath 23, the first cutter assembly sheath 22 and the second cutter assembly sheath 23 could be simultaneously rotated even if the cutting mechanism 2 of the present invention has only a lead screw. The use of a single lead screw reduces the fabricating cost of the cutting mechanism. In addition, the method for controlling simultaneous movement of the first blade 202 and the second blade 212 is simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cutting mechanism for cutting a sheet-like article, said cutting mechanism comprising:
a first cutter assembly for cutting said sheet-like article;
a first cutter assembly sheath for clamping said first cutter assembly;
a first guiding shaft penetrating through said first cutter assembly, wherein said first cutter assembly is movable along said first guiding shaft;
a second cutter assembly for cutting said sheet-like article;
a second cutter assembly sheath for clamping said second cutter assembly;
a second guiding shaft penetrating through said second cutter assembly, wherein said second cutter assembly is movable along said second guiding shaft;
a connecting element having both ends respectively connected to said first cutter assembly sheath and said second cutter assembly sheath, so that said first cutter assembly sheath and said second cutter assembly sheath are simultaneously moved;
a lead screw sheath connected to said first cutter assembly sheath; and
a lead screw penetrating through said lead screw sheath,
wherein said lead screw sheath is moved along said lead screw upon rotation of said lead screw, so that said first cutter assembly sheath and said second cutter assembly sheath are simultaneously moved to a cutting position, and said sheet-like article at said cutting position is cut by said first cutter assembly and said second cutter assembly.

2. The cutting mechanism according to claim 1 wherein said first cutter assembly comprises a first cutter frame and a first blade, and said second cutter assembly comprises a second cutter frame and a second blade.

3. The cutting mechanism according to claim 2 wherein said first blade is disposed on said first cutter frame, and said second blade is disposed on said second cutter frame.

4. The cutting mechanism according to claim 3 wherein said connecting element is arranged behind said first blade and said second blade, and said connecting element has a tapering protrusion for guiding said shredded sheet-like article to be ejected along an exit path.

5. The cutting mechanism according to claim 4 wherein a protruding edge is further circumferentially arranged on a periphery of said first cutter frame.

6. The cutting mechanism according to claim 5 further comprising a spring sheathed around said first cutter frame, wherein an end of said spring is sustained against said protruding edge, so that said first blade is sustained against said second blade.

7. The cutting mechanism according to claim 1 wherein said first guiding shaft and said second guiding shaft are square-section shafts.
